(19) United States
(12) Patent Application Publication
(10) Pub. No.: US 2013/0152742 A1
(43) Pub. Date: Jun. 20, 2013

(54) WRENCH WITH RATCHET DEVICE

(71) Applicant: Yi-Fu Chen, Taichung City (TW)

(72) Inventor: Yi-Fu Chen, Taichung City (TW)

(21) Appl. No.: 13/326,348

(22) Filed: Dec. 15, 2011

(51) Int. Cl. B25B 13/46

(52) U.S. Cl. 81/63.1

(57) ABSTRACT

A wrench with ratchet device includes a wrench body, a ratchet and a control set. The wrench body has a receiving room and a switch room defined therein. The switch room has an opening defined at the front side of the wrench body. A ratchet is assembled into the receiving room and the switch room. A control set assembled into the switch room further comprises two driving blocks, a control member and a switch member. Under this arrangement, when the switch member is moved to one direction, the ratchet is only rotated along the one direction incrementally by one driving block boosting. In contrast, when the ratchet is forced to rotate to the opposite direction, the ratchet is free rotating and not working.

### BACKGROUND OF THE INVENTION

1. Field of the Invention

The present invention relates to a wrench, more particularly to a wrench with ratchet device for definitely directional operation, in which the cost to produce the present invention is lower than the conventional ratchet wrench.

2. Description of Related Art

A conventional wrench is used to attach or to detach bolts and nuts from an article. The conventional wrench has an adjustable jaw for matching to the size of bolt and nut. In this way, the jaw can engage with the bolt and nut for a user to attach or detach. However, when the user operates the conventional wrench to attach or to detach the bolt and nut, the conventional wrench is needed to separate from the bolt and nut for repositioning after each screwing or rotating. It is inconvenient for the user.

In order to overcome the above shortcoming, some manufacturer combines a ratchet device into the wrench. The improved ratchet wrench comprises a wrench body, a ratchet, a switch button and a device for adjusting the operative direction. The wrench body has a receiving room defined as a head portion. A switch room is defined near the receiving room. A control room is communicated with the switch room. The ratchet is placed into the receiving room. The switch button is placed into the switch room. The switch button is engaged with the ratchet. The device for adjusting the operative direction is placed into the control room. The switch button has a hole defined at the bottom and a slot defined laterally. The slot is near the hole. The device for adjusting the operative direction includes a block, an elastic member assembled on the block, and a control plate. One end of the elastic member is received into the hole of the switch button for pushing the switch button to engage with the ratchet. One end of the control plate is received into the slot of the switch button for preventing the elastic member from drop.

Unfortunately, the improved ratchet wrench has a precise structure so that the cost to produce the ratchet wrench is expensive. For example, if the teeth of the ratchet are too sharp, the switch button is easy to engage with the ratchet but difficult to disengage. In addition, the space of the switch room must match to the switch button, otherwise the gap between the switch button and the ratchet might cause the ratchet wrench not to work. Thus, to produce a pair of useful switch button and ratchet often costs a lot of time and money. How to improve the construction of the switch button and the ratchet becomes an important issue in this field.

The present invention has arisen to mitigate and/or obviate the disadvantages of the conventional.

### SUMMARY OF THE INVENTION

The main objective of the present invention is to provide an improved wrench with ratchet device for definitely directional operation.

To achieve the objective, a wrench with ratchet device comprises a wrench body, the wrench body having a receiving room defined therein, a switch room defined below the receiving room and communicated with the receiving room, the switch room having an opening defined at the front side of the wrench body, a ratchet assembled into the receiving room, a part of the ratchet being exposed in the switch room, a control set assembled into the switch room, the control set further comprising a first spring, two driving blocks, a control member and a switch member, the two driving blocks elastically connected by the first spring, the control member formed as a Y-shaped plate, the top portion of the Y-shaped control member assembled to the two driving blocks respectively, the bottom portion of the Y-shaped control member assembled into the switch member, each of the driving blocks selectively engaged or disengaged with the ratchet; thereby when the switch member is moved to one direction, one driving block corresponding to the one direction is engaged with the ratchet and another driving block is disengaged with the ratchet so that the ratchet can only rotate to the one direction incrementally and one driving block can boost the ratchet to rotate to the one direction; but when the ratchet is forced to rotate to the opposite direction, the first spring is compressed and the driving blocks are both disengaged with the ratchet so that the ratchet is free rotating and not working.

Two grooves are defined on the bottom of the switch room at left and right side respectively, a second hole defined at the bottom of the switch member, a second spring assembled between the second hole and the groove, the second spring having a bead and a spring body, one end of the spring body received into the second hole, another end of the spring body connected to the bead, the bead located between the second hole and one of the grooves.

Two ribs construct the top portion of the Y-shaped control member, each of the driving blocks having a connecting room defined therein for engaging with the rib.

Each of the driving blocks has a first hole respectively, the two first holes face to face from each other, the first spring resisted against the two first holes of the two driving blocks.

A positioning slot is defined on the top of the switch member for assembling the bottom portion of the control member.

A protrusion is deposed in front of the switch member; thereby a user can poke the protrusion to drive the switch member moving left and right in the switch room, and one of the driving blocks is selectively engaged with the ratchet.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a wrench with ratchet device in accordance with the present invention;

FIG. 2 is an assembled view of the wrench with ratchet device in accordance with the present invention;

FIG. 3 is a cross-sectional view of the wrench with ratchet device along line A-A shown in FIG. 2;

FIG. 4 is a front side view for showing the wrench with ratchet device to be operated clockwise; and

FIG. 5 is a front side view for showing the wrench with ratchet device to be operated counterclockwise.

### DETAILED DESCRIPTION OF THE INVENTION

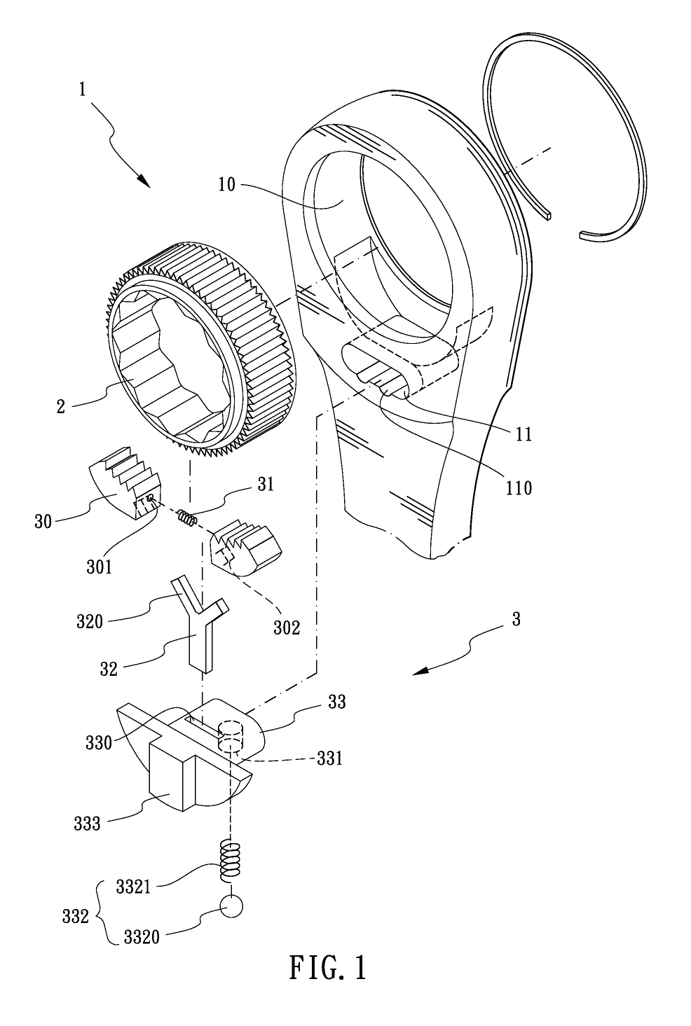

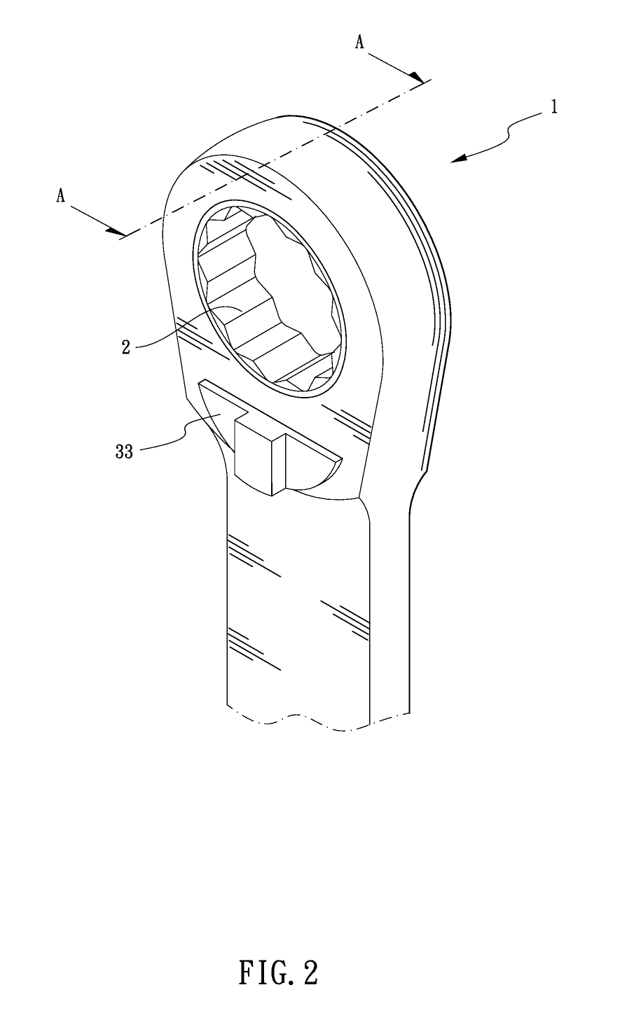

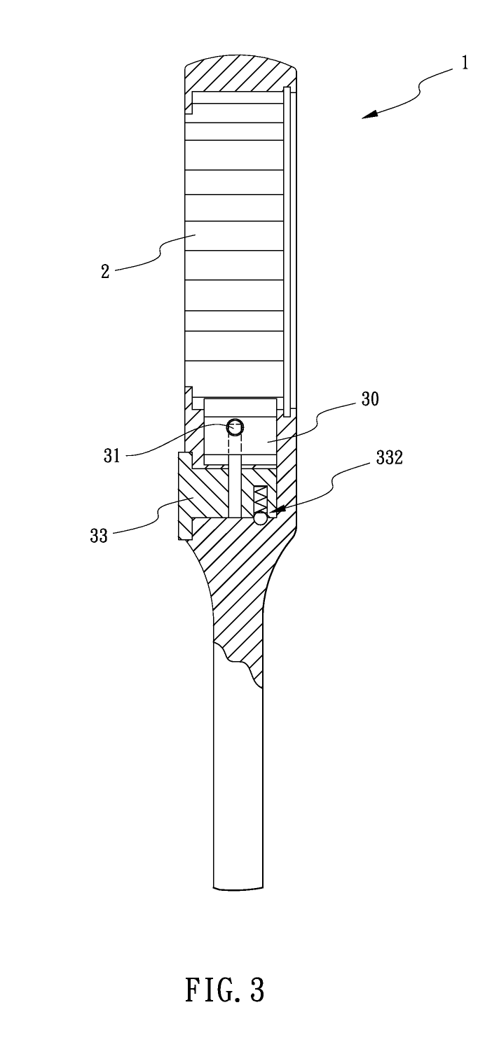

Referring to the FIGS. 1-3, a wrench with ratchet device in accordance with the present invention comprises a wrench body 1, a ratchet 2 and a control set 3.

The wrench body 1 has a receiving room 10 defined therein. A switch room 11 is defined below the receiving room 10 and communicated with the receiving room 10. The switch room 11 has an opening defined at the front side of the wrench body 1. Two grooves 110 are defined on the bottom of the switch room 11 at left and right side respectively.

The ratchet 2 is assembled into the receiving room 10. A part of the ratchet 2 is exposed in the switch room 11.

The control set 3 is assembled into the switch room 11. The control set 3 further comprises two driving blocks 30, a first spring 31, a control member 32 and a switch member 33. Each of the driving blocks 30 is respectively engaged with the ratchet 2. Each of the driving blocks 30 has a first hole 301 respectively. The two first holes 301 are face to face from each other. A first spring 31 is resisted against to the two first holes 301 of the two driving blocks 30, thereby the two driving blocks 30 are elastically connected by the first spring 31. The control member 32 is formed as a Y-shaped plate. Two ribs 320 construct the top portion of the Y-shaped control member 32. Each of the driving blocks 30 has a connecting room 302 defined therein for engaging with the rib 320. The bottom portion of the Y-shaped control member 32 is assembled into the switch member 33. A positioning slot 330 is defined on the top of the switch member 33 for assembling the bottom portion of the control member 32. The switch member 33 is formed as an ellipse corresponding to the switch room 11. The switch member 33 can move from left to right in the switch room 11. A second hole 331 is defined at the bottom of the switch member 33. A second spring 332 is assembled between the second hole 331 and the groove 110. The second spring 332 has a bead 3320 and a spring body 3321. One end of the spring body 3321 is received into the second hole 331. Another end of the spring body 3321 connects to the bead 3320. The bead 3320 can slide along the surface of the switch room 11. When the bead 3320 is pressed into the second hole 331 and recovering to the groove 110, the bead 3320 is constrained by the groove 110 so that the switch member 33 is positioned. A protrusion 333 is deposed in front of the switch member 33. A user can poke the protrusion 333 to drive the switch member 33 moving left and right in the switch room 11, thereby one of the driving blocks 30 is selectively engaged with the ratchet 2.

Under this arrangement, when the switch member 33 is moved to the left (right), the left (right) driving block 30 is engaged with the ratchet 2 and the right (left) driving block 30 is disengaged with the ratchet 2 so that the ratchet 2 can only rotate to the left (right) incrementally and the left (right) driving block 30 can boost the ratchet 2 to rotate to the left (right). However, when the ratchet 2 is rotated to the opposite direction, the first spring 31 is compressed and the driving blocks 30 are both disengaged with the ratchet 2. Thus, the ratchet 2 is free rotating.

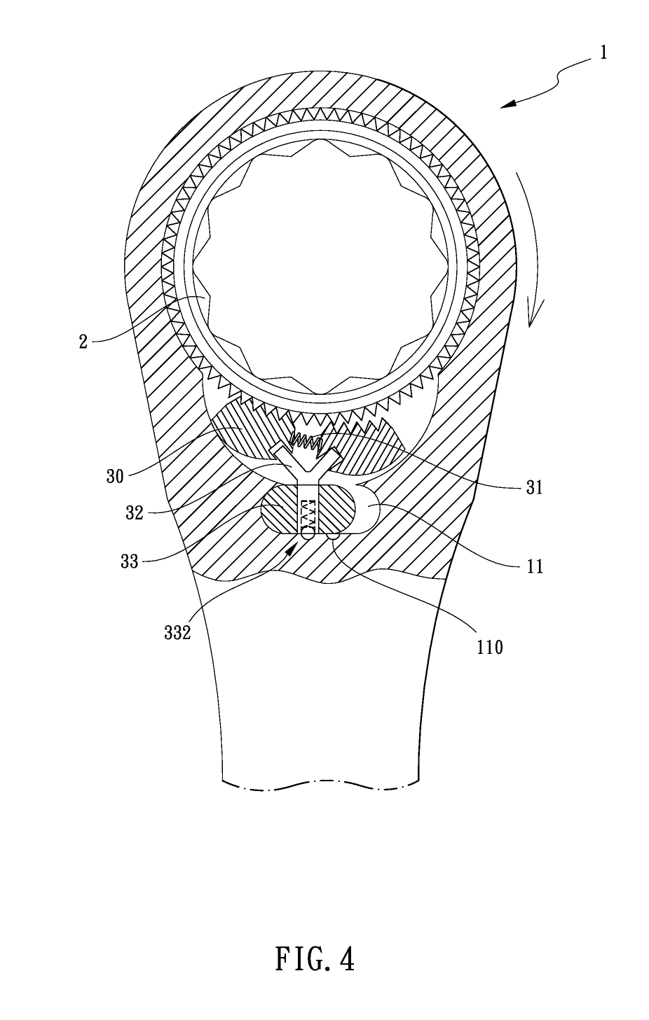

Referring to the FIG. 4, the switch member 33 is moved to the left so that the second spring 332 is constrained into the left groove 110 of the switch room 11. Moreover, the control member 32 is moving to the left and the left rib 320 of the control member 32 is pushing the left driving block 30 to make the left driving block 30 engage with the ratchet 2. In contrast, the right driving block 30 is disengaged with the ratchet 2. When the ratchet 2 is forced to rotate counterclockwise, the first spring 31 is compressed and the driving blocks 30 are both disengaged with the ratchet 2. Thus, the ratchet 2 is only rotating clockwise.

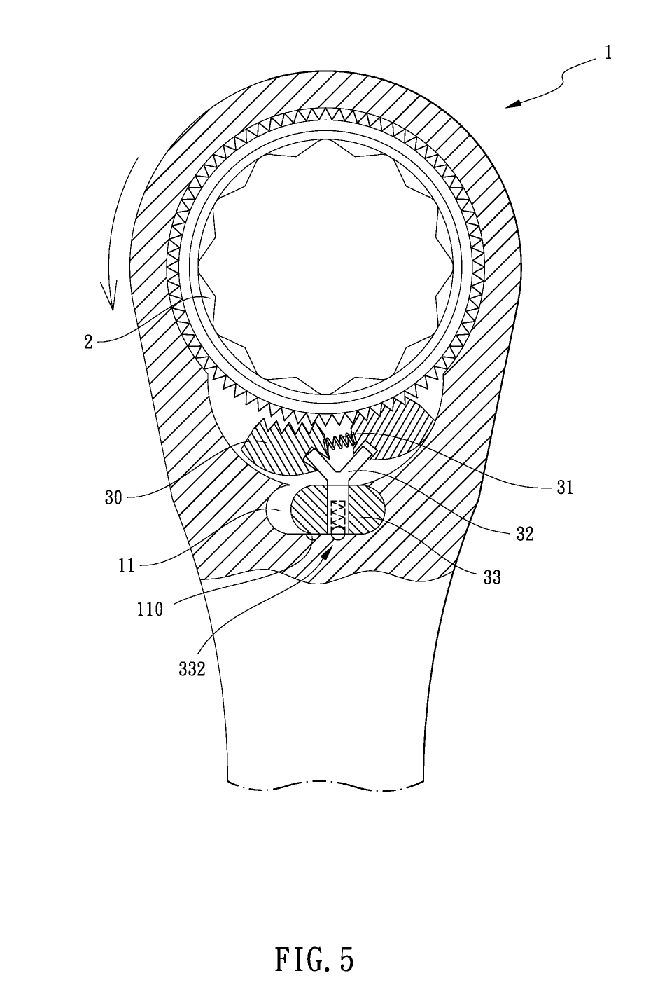

Referring to the FIG. 5, the switch member 33 is moved to the right so that the second spring 332 is constrained into the right groove 110 of the switch room 11. Moreover, the control member 32 is moving to the right and the right rib 320 of the control member 32 is pushing the right driving block 30 to make the right driving block 30 engage with the ratchet 2. In contrast, the left driving block 30 is disengaged with the ratchet 2. When the ratchet 2 is forced to rotate clockwise, the first spring 31 is compressed and the driving blocks 30 are both disengaged with the ratchet 2. Thus, the ratchet 2 is only rotating counterclockwise.

Although the invention has been explained in relation to its preferred embodiment, it is to be understood that many other possible modifications and variations can be made without departing from the spirit and scope of the invention as hereinafter claimed.

What is claimed is:

1. A wrench with ratchet device comprising:
a wrench body, the wrench body having a receiving room defined therein, a switch room defined below the receiving room and communicated with the receiving room, the switch room having an opening defined at the front side of the wrench body;
a ratchet assembled into the receiving room, a part of the ratchet being exposed in the switch room; and
a control set assembled into the switch room, the control set further comprising a first spring, two driving blocks, a control member and a switch member, the two driving blocks elastically connected by the first spring, the control member formed as a Y-shaped plate, the top portion of the Y-shaped control member assembled to the two driving blocks respectively, the bottom portion of the Y-shaped control member assembled into the switch member, each of the driving blocks selectively engaged or disengaged with the ratchet;
thereby when the switch member is moved to one direction, one driving block corresponding to the one direction is engaged with the ratchet and another driving block is disengaged with the ratchet so that the ratchet can only rotate to the one direction incrementally and one driving block can boost the ratchet to rotate to the one direction; but when the ratchet is forced to rotate to the opposite direction, the first spring is compressed and the driving blocks are both disengaged with the ratchet so that the ratchet is free rotating and not working.

2. The wrench with ratchet device as claimed in claim 1, wherein two grooves are defined on the bottom of the switch room at left and right side respectively, a second hole defined at the bottom of the switch member, a second spring assembled between the second hole and the groove, the second spring having a bead and a spring body, one end of the spring body received into the second hole, another end of the spring body connected to the bead, the bead located between the second hole and one of the grooves.

3. The wrench with ratchet device as claimed in claim 1, wherein two ribs construct the top portion of the Y-shaped control member, each of the driving blocks having a connecting room defined therein for engaging with the rib.

4. The wrench with ratchet device as claimed in claim 1, wherein each of the driving blocks has a first hole respectively, the two first holes face to face from each other, the first spring resisted against the two first holes of the two driving blocks.

5. The wrench with ratchet device as claimed in claim 1, wherein a positioning slot is defined on the top of the switch member for assembling the bottom portion of the control member.

6. The wrench with ratchet device as claimed in claim 1, wherein a protrusion is deposed in front of the switch member; thereby a user can poke the protrusion to drive the switch member moving left and right in the switch room, and one of the driving blocks is selectively engaged with the ratchet.
